(19) United States
(12) Patent Application Publication
(10) Pub. No.: US 2017/0168195 A1
(43) Pub. Date: Jun. 15, 2017

(54) METHOD FOR FORECASTING FLOODS FOR MULTIPLE LEAD TIMES

(71) Applicant: Wuhan University, Wuhan (CN)

(72) Inventors: Yan ZHAO, Wuhan (CN); Pan LIU, Wuhan (CN); Chao DENG, Wuhan (CN)

(21) Appl. No.: 15/377,974

(22) Filed: Dec. 13, 2016

(30) Foreign Application Priority Data
Dec. 15, 2015 (CN) 201510932746.0

(51) Int. Cl. G01W 1/10; G06F 17/11; G06F 17/50

(52) U.S. Cl. CPC G01W 1/10; G06F 17/5009; G06F 17/11

(57) ABSTRACT

A method for forecasting flood, the method including: 1) collecting historical flood information, estimating a mean concentration time of a basin, and determining a length of a lead time; 2) establishing hydrological models, inputting hydrological variables including precipitation and evaporation to the hydrological models while neglecting the precipitation within lead times; 3) determining an objective function, which is a sum of squared errors between a forecasted streamflow and an observed streamflow within multiple lead times, and utilizing optimized algorithms to calibrate hydrological model parameters; and 4) selecting criteria to evaluate forecasting performance of the hydrological model including a Nash-Sutcliffe efficiency, a root mean square error, a water balance index, a qualified rate of peak flow, and a qualified rate of a peak time.

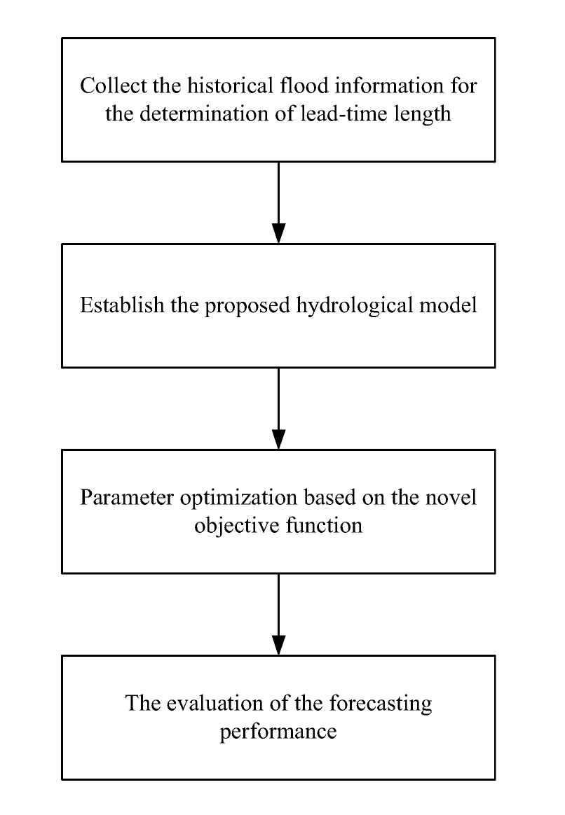

### CROSS-REFERENCE TO RELATED APPLICATIONS

Pursuant to 35 U.S.C. §119 and the Paris Convention Treaty, this application claims the benefit of Chinese Patent Application No. 201510932746.0 filed Dec. 15, 2015, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a method for forecasting floods during multiple lead times.

Description of the Related Art

Traditional technique for flood forecasting is as follows: 1) collect historical hydrological data for the study basin, 2) establish a hydrological model, 3) implement parameters calibration with a determined objective function, and 4) evaluate the performance of the hydrological forecasting model with criteria.

In general, the traditional method uses real-time observed or weather predicted rain fall data. The forecasting accuracy is strongly impacted due to the uncertainty of rainfall during lead times.

The traditional method addresses hydrological simulation rather than forecasting; thus, the objective functions are built to reflect the rain-runoff relationship, which do not have forecasting ability.

The evaluation criteria only focus on the current streamflow, which is unable to simultaneously describe the forecasted results within multiple lead times.

### SUMMARY OF THE INVENTION

In view of the above-described problems, it is one objective of the invention to provide a method for forecasting floods during multiple lead times.

To achieve the above objective, in accordance with one embodiment of the invention, there is provided a method for forecasting flood during multiple lead times. The method comprises:
1) collecting historical flood information, estimating a mean concentration time of a basin, and determining a length of a lead time;
2) establishing hydrological models, inputting hydrological variables comprising precipitation and evaporation to the hydrological models while neglecting the precipitation within lead times;
3) determining an objective function, utilizing optimized algorithms to calibrate hydrological model parameters, which is a sum of squared errors between a forecasted streamflow and an observed streamflow within multiple lead times as follows:

$$min F = {\sum }_{t = 1}^{N} ( {( {Q}_{t}^{obs} - {Q}_{t , t - 1}^{pre} )}^{2} + {( {Q}_{t}^{obs} - {Q}_{t , t - 2}^{pre} )}^{2} + … + {( {Q}_{t}^{obs} - {Q}_{t , t - k}^{pre} )}^{2} ) \qquad ( 1 )$$

where Qₜ^{obs} is the observed streamflow at time t (t=1, 2, . . . , N), Q_{t,t-k}^{pre} is the forecasted streamflow at time t which is based on inputs of forecast-time k hours earlier than the time t, N is a total number of observations; and
4) selecting criteria to evaluate forecasting performance of the hydrological model comprising a Nash-Sutcliffe efficiency, a root mean square error, a water balance index, a qualified rate of peak flow, and a qualified rate of a peak time.

Advantages of the method for forecasting flood during multiple lead times according to embodiments of the invention are summarized as follows:
1. The objective function of the method is able to improve the forecasting ability during multiple lead times.
2. The method of the invention is adapted to the flood forecasting and is able to simultaneously implement the multiple forecast-time flood forecasts, which not only can enhance the forecasting accuracy but also lengthen the forecasted lead time for the flood mitigation.
3. The method of the invention is able to determine the maximum length of lead times, i.e., the ahead time for forecasting.

### BRIEF DESCRIPTION OF THE DRAWINGS

The invention is described herein below with reference to accompanying drawings, in which the sole FIGURE is a flow chart illustrating a method for forecasting flood during multiple lead times according to one embodiment of the invention.

### DETAILED DESCRIPTION OF THE EMBODIMENTS

For further illustrating the invention, experiments detailing a method for forecasting flood during multiple lead times are described below. It should be noted that the following examples are intended to describe and not to limit the invention.

As shown in the sole FIGURE, a method for forecasting flood during multiple lead times are as follows:

Step 1: Collect the historical flood information to estimate the mean concentration time of the basin, which is set for the length of lead time.

Step2: Input the hydrological variables (i.e. precipitation and evaporation) to the established hydrological models, without considering the precipitation within lead times.

Step 3: Utilize the optimized algorithms to calibrate the hydrological model parameters by a novel objective function, which is sum of the squared errors between the forecasted and observed streamflow within multiple lead times as follows.

$$min F = {\sum }_{t = 1}^{N} ( {( {Q}_{t}^{obs} - {Q}_{t , t - 1}^{pre} )}^{2} + {( {Q}_{t}^{obs} - {Q}_{t , t - 2}^{pre} )}^{2} + … + {( {Q}_{t}^{obs} - {Q}_{t , t - k}^{pre} )}^{2} ) \qquad ( 1 )$$

where Qₜ^{obs} is the observed streamflow at time t (t=1, 2, . . . , N), Q_{t,t-k}^{pre} is the forecasted streamflow at time t which is based on the inputs of the forecast-time k hours earlier than the time t, N is the total number of the observations.

The parameters are calibrated not only by using a single optimized algorithm but also by various combined algorithms, such as the estimated parameters of Genetic algorithm can be treated as the initial values of the Rosen Brock methods, as well as the estimates of Rosen Brock methods can treated as the initial values of Simplex method.

Step 4: select the widely used criteria to evaluate forecasting performance of the hydrological model, i.e. the Nash-Sutcliffe efficiency (NSE), Root Mean Square Error (RMSE), Water balance index (WBI), the qualified rate of peak flow (QRF) and the qualified rate of peak time (QRT).

The formulas are as follows:

$$\begin{matrix}N S E = 1 - \frac{{\sum }_{t = 1}^{N} {( {Q}_{t}^{pre} - {Q}_{t}^{obs} )}^{2}}{{\sum }_{t = 1}^{N} {( {Q}_{t}^{obs} - \overline{{Q}_{obs}} )}^{2}} & ( 2 ) \\ R M S E = \sqrt{\frac{{\sum }_{t = 1}^{N} {( {Q}_{t}^{pre} - {Q}_{t}^{obs} )}^{2}}{N}} & ( 3 ) \\ Q R F = \frac{NF}{M} & ( 4 ) \\ Q R T = \frac{NT}{M} & ( 5 )\end{matrix}$$

where Qₜ^{pre} is the predicted streamflow at time t; Q̅_̅{̅o̅b̅s̅}̅ is the mean value of the observed streamflow; Wₚᵣₑ, W_{obs} are the total volume of the predicted and observed flow, respectively; NF is the number of the qualified flood events about peak flow; NT is the number of the qualified flood events about peak time; M is the total flood events.

Case Study

The Baiyunshan Reservoir in Jiangxi Province is taken as an example, which is located in the Fushui River basin, the secondary tributary of the Yangtze River in China. Flood control, irrigation and hydropower are the main functions of the reservoir. It has a drainage area of 464 km² and total storage capacity of 1.14 million m³. The reservoir lies in the subtropical region and is governed by the tropical monsoon climate with annual mean precipitation of 1161.3 mm and evaporation of 975 mm The average streamflow, average annual flow volume and average runoff depth at the dam site are 12.5 m³/s, 3.94 million m³ and 850 mm The river floods due to the frontal weather systems occur in April-July, or due to typhoon storms (the northeast Pacific hurricanes) in July-September. The masonry gravity dam has a height of 48 m, a length of 91.5 m and the dam crest elevation of 174 m.

Three hydrological gauged stations observed both of rain, pan evaporation and streamflow, nine rain gauged stations, and one water level station of the reservoir are spreading over the basin. Among these stations, there are two relay stations (Donggu and Huangsha) and one central station (Bashang), and the outlet of the basin is at the Baiyunshan Reservoir. Hourly precipitation, pan evaporation and streamflow data set during flood seasons are used. Across the period 1994-2000, 18 flood events are selected to calibrate and validate the model. The first 13 flood events, which occurred between 1994 and 1998, are used for the calibration, and the remainder 5 events, which is from 1999-2000, are served for the validation.

The proposed and conventional methods are both used for the flood forecasting. The conventional method is implemented for 6 h ahead; while the proposed method is applied for lead times of 3, 4, 5 and 6 h, respectively. The Xinanjiang model is then calibrated to produce five sets of parameters, i.e., parameters for the conventional method, the proposed method with lead times of 3, 4, 5 and 6 h, respectively. The NSE, RMSE, WBI, QRF and QRT have been used as the evaluation indicators.

TABLE 1
Performance evaluation for flood forecasting of the conventional and
proposed methods

| | | Lead | Calibration | | | | | Validation | | | | |
|---|---|---|---|---|---|---|---|---|---|---|---|---|
| | | time | | | | QRF | QRT | | | | QRF | QRT |
| Scheme | | (hr.) | NSE | WBI | RMSE | (%) | (%) | NSE | WBI | RMSE | (%) | (%) |
| Conventional | | 1 | 0.91 | 0.01 | 14.71 | 84.6 | 100.0 | 0.88 | 0.08 | 13.95 | 60 | 100 |
| method | | 2 | 0.91 | 0.03 | 15.17 | 84.6 | 100.0 | 0.88 | 0.06 | 13.99 | 60 | 100 |
| | | 3 | 0.87 | 0.06 | 17.68 | 61.5 | 100.0 | 0.86 | 0.03 | 14.94 | 60 | 100 |
| | | 4 | 0.80 | 0.10 | 22.20 | 53.8 | 92.3 | 0.80 | 0.00 | 17.88 | 20 | 100 |
| | | 5 | 0.71 | 0.13 | 26.80 | 15.4 | 76.9 | 0.71 | 0.04 | 21.34 | 20 | 100 |
| | | 6 | 0.62 | 0.16 | 30.61 | 7.7 | 53.8 | 0.63 | 0.07 | 24.41 | 0 | 80 |
| | 3 h | 1 | 0.91 | 0.01 | 15.21 | 84.6 | 100.0 | 0.86 | 0.12 | 14.88 | 60 | 100 |
| | | 2 | 0.91 | 0.01 | 15.21 | 84.6 | 100.0 | 0.86 | 0.10 | 14.71 | 60 | 100 |
| | | 3 | 0.88 | 0.04 | 16.92 | 76.9 | 100.0 | 0.86 | 0.07 | 15.08 | 60 | 100 |
| | 4 h | 1 | 0.90 | 0.00 | 15.90 | 76.9 | 100.0 | 0.85 | 0.11 | 15.27 | 80 | 100 |
| | | 2 | 0.89 | 0.01 | 16.05 | 76.9 | 100.0 | 0.85 | 0.10 | 15.31 | 80 | 100 |
| | | 3 | 0.88 | 0.03 | 16.89 | 76.9 | 100.0 | 0.85 | 0.07 | 15.53 | 80 | 100 |
| | | 4 | 0.83 | 0.08 | 20.34 | 69.2 | 100.0 | 0.81 | 0.03 | 17.58 | 80 | 100 |
| Proposed | 5 h | 1 | 0.89 | 0.02 | 16.45 | 76.9 | 100.0 | 0.85 | 0.15 | 15.64 | 80 | 100 |
| method | | 2 | 0.89 | 0.02 | 16.61 | 76.9 | 100.0 | 0.85 | 0.14 | 15.68 | 80 | 100 |
| | | 3 | 0.88 | 0.01 | 17.47 | 69.2 | 100.0 | 0.84 | 0.12 | 15.93 | 80 | 100 |
| | | 4 | 0.83 | 0.04 | 20.44 | 69.2 | 92.3 | 0.81 | 0.08 | 17.63 | 60 | 100 |
| | | 5 | 0.75 | 0.09 | 24.86 | 46.2 | 84.6 | 0.73 | 0.03 | 20.59 | 20 | 100 |
| | 6 h | 1 | 0.89 | 0.03 | 16.63 | 76.9 | 100.0 | 0.85 | 0.16 | 15.54 | 60 | 100 |
| | | 2 | 0.88 | 0.02 | 16.79 | 76.9 | 100.0 | 0.85 | 0.15 | 15.43 | 60 | 100 |
| | | 3 | 0.87 | 0.01 | 18.02 | 76.9 | 100.0 | 0.85 | 0.12 | 15.60 | 60 | 100 |
| | | 4 | 0.82 | 0.04 | 21.27 | 69.2 | 92.3 | 0.81 | 0.08 | 17.44 | 60 | 100 |
| | | 5 | 0.74 | 0.08 | 25.29 | 53.8 | 76.9 | 0.74 | 0.04 | 20.21 | 40 | 100 |
| | | 6 | 0.66 | 0.11 | 28.96 | 38.5 | 61.5 | 0.67 | 0.00 | 23.01 | 20 | 80 |

The performances of conventional and proposed methods are compared in Table 1. As expected, the forecasting accuracies decreases with increasing lead time length. The values of the NSE index for the two methods almost exceed 0.70 both in the model calibration and validation, which are considered sufficiently reliable for practical forecasting application. It can be seen that the NSE values of the proposed method from lead time 3 to 6 h are slightly less than the conventional method for shorter lead time and better for longer lead time. According to the Chinese standard on hydrological forecasting, lead time of 6 h is identified as the maximum forecasting time with acceptable accuracy of NSE. The RMSE values increase with increasing lead time for the calibration and validation. In terms of WBI index, the values of proposed method are slightly smaller than those of the conventional method for the calibration, indicating that the proposed method is more effective for the water balance criterion. For QRF index, the QRF values of 4, 5 and 6 h lead times of the proposed method are 69.2%, 53.8% and 38.5%, while the conventional method has a value of 53.8%, 15.4% and 7.7% with the longest forecasting lead time of 6 h for the calibration. Generally, the QRT values are slightly improved by the proposed method compared to the conventional method. As shown in Table 1, the results of the two methods indicate that they are effective to the practical implementation for forecasting 5 h lead time flows. In contrast, the proposed model shows the better performance especially for 4-6 h lead times forecasts and has significant improvements in the flood event peak flow and timing of the flood peak.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for forecasting flood, the method comprising:
1) collecting historical flood information, estimating a mean concentration time of a basin, and determining a length of a lead time;
2) establishing hydrological models, inputting hydrological variables comprising precipitation and evaporation to the hydrological models while neglecting the precipitation within lead times;
3) determining an objective function, utilizing optimized algorithms to calibrate hydrological model parameters, which is a sum of squared errors between a forecasted streamflow and an observed streamflow within multiple lead times as follows:
$$min F = {\sum }_{t = 1}^{N} ( {( {Q}_{t}^{obs} - {Q}_{t , t - 1}^{pre} )}^{2} + {( {Q}_{t}^{obs} - {Q}_{t , t - 2}^{pre} )}^{2} + … + {( {Q}_{t}^{obs} - {Q}_{t , t - k}^{pre} )}^{2} )$$
where Qₜ^{obs} is the observed streamflow at time t (t=1, 2, . . . , N), Q_{t,t-k}^{pre} is the forecasted streamflow at time t which is based on inputs of forecast-time k hours earlier than the time t, N is a total number of observations; and
4) selecting criteria to evaluate forecasting performance of the hydrological model comprising a Nash-Sutcliffe efficiency, a root mean square error, a water balance index, a qualified rate of peak flow, and a qualified rate of a peak time.
